(19) United States
(12) Patent Application Publication
(10) Pub. No.: US 2025/0042136 A1
(43) Pub. Date: Feb. 6, 2025

(54) MULTI-MATERIAL LAMINATION

(71) Applicant: Gentex Corporation, Zeeland, MI (US)

(72) Inventors: Joel A. Stray, Grand Haven, MI (US); Matthew A. Koppey, West Olive, MI (US); Eric A. Gobrogge, Hudsonville, MI (US); Michael T. Stephenson, Holland, MI (US); Derek J. Marshall, Jenison, MI (US); Andrew T. Mitchell, Hudsonville, MI (US); Brandon W. Whitman, Grandville, MI (US); Jason A. Musthaler, Rockford, MI (US); Erik John Larkin Helton, Hudsonville, MI (US)

(73) Assignee: Gentex Corporation, Zeeland, MI (US)

(21) Appl. No.: 18/792,995

(22) Filed: Aug. 2, 2024

Related U.S. Application Data
(60) Provisional application No. 63/530,734, filed on Aug. 4, 2023.

(51) Int. Cl. B32B 17/10; B32B 7/12; G02F 1/161

(52) U.S. Cl. CPC B32B 17/10495; B32B 7/12; B32B 17/10036; B32B 17/10761; G02F 1/161; B32B 2605/00; G02F 2203/48

(57) ABSTRACT

A variable transmission element includes a first substrate that has a first surface and a second surface opposite the first surface. A second substrate includes a third surface and a fourth surface opposite the third surface. The first and second surfaces face each other and are disposed in a spaced apart relationship so as to define a space therebetween. A seal formed of a sealing material extends along a perimeter of the first and second substrates. A first lamination layer comprises a first lamination material that is different from the sealing material and the first lamination layer is coupled to the second surface. A second lamination layer comprises a second lamination material that is different from the sealing material and the second lamination layer is coupled to the second substrate. An electro-optic device is disposed between the first lamination layer and the second lamination layer.

### CROSS-REFERENCE TO RELATED APPLICATION

This application claims priority to and the benefit under 35 U.S.C. § 119 (e) of U.S. Provisional Application No. 63/530,734, filed on Aug. 4, 2023, entitled “MULTI-MATERIAL LAMINATION,” the disclosure of which is hereby incorporated herein by reference in its entirety.

### FIELD OF THE DISCLOSURE

The present disclosure generally relates to a variable transmission element, and more particularly to a window or a mirror with variable transmission having a multi-material lamination.

### SUMMARY OF THE DISCLOSURE

According to one aspect of the present disclosure, a variable transmission element includes a first substrate that has a first surface and a second surface opposite the first surface. A second substrate includes a third surface and a fourth surface opposite the third surface. The first and second substrates are disposed in a spaced apart relationship so as to define a space therebetween with the second and third surfaces facing each other. A seal is formed of a sealing material and extends along a perimeter of the first and second substrates. A first lamination layer comprises a first lamination material that is different from the sealing material and the first lamination layer is coupled to the second surface. A second lamination layer comprises a second lamination material that is different from the sealing material and the second lamination layer is coupled to the second substrate. An electro-optic device is disposed between the first lamination layer and the second lamination layer.

According to another aspect of the present disclosure, a variable transmission element includes a first substrate that has a first surface and a second surface opposite the first surface. A second substrate includes a third surface and a fourth surface opposite the third surface. The first and second substrates are disposed in a spaced apart relationship so as to define a space therebetween with the second and third surfaces facing each other. A first lamination layer comprises a first lamination material and the first lamination layer is coupled to the second surface. A second lamination layer comprises a second lamination material that is different from the first lamination material and the second lamination layer is coupled to the second substrate. An electro-optic device is disposed between the first lamination layer and the second lamination layer.

According to yet another aspect of the present disclosure, a variable transmission element includes a first substrate that has a first surface and a second surface opposite the first surface. A second substrate includes a third surface and a fourth surface opposite the third surface. The first and second substrates are disposed in a spaced apart relationship so as to define a space therebetween with the second and third surfaces facing each other. An electro-optic device disposed between the first and second substrates. A seal formed of a sealing material that does not include thermoplastic polyurethane (“TPU”), polyvinyl butyral (“PVB”), ethylene vinyl acetate (“EVA”) extends along a perimeter of the first and second substrates. A first lamination layer comprises a first lamination material selected from a group comprising TPU, PVB, and EVA that is located between the second surface and the electro-optic device. A second lamination layer comprises a second lamination material selected from a group comprising TPU, PVB, and EVA that is located between the third surface and the electro-optic device.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1A is a variable transmission element of a first construction, according to an aspect of the present disclosure;

FIG. 1B is a variable transmission element of a second construction, according to an aspect of the present disclosure;

FIG. 1C is a seal of a variable transmission element, according to an aspect of the present disclosure;

FIG. 2A is a top plan view of a vehicle incorporating a variable transmission element in accordance with the present disclosure;

FIG. 2B is a top perspective view of an aircraft incorporating a variable transmission element in accordance with the present disclosure;

FIG. 2C is a front elevational view of a building incorporating a variable transmission element in accordance with the present disclosure; and

FIG. 2D is a top perspective view of an eyewear assembly incorporating a variable transmission element in accordance with the present disclosure.

### DETAILED DESCRIPTION

The present illustrated embodiments reside primarily in combinations of method steps and apparatus components related to a variable transmission element having a multi-material lamination. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

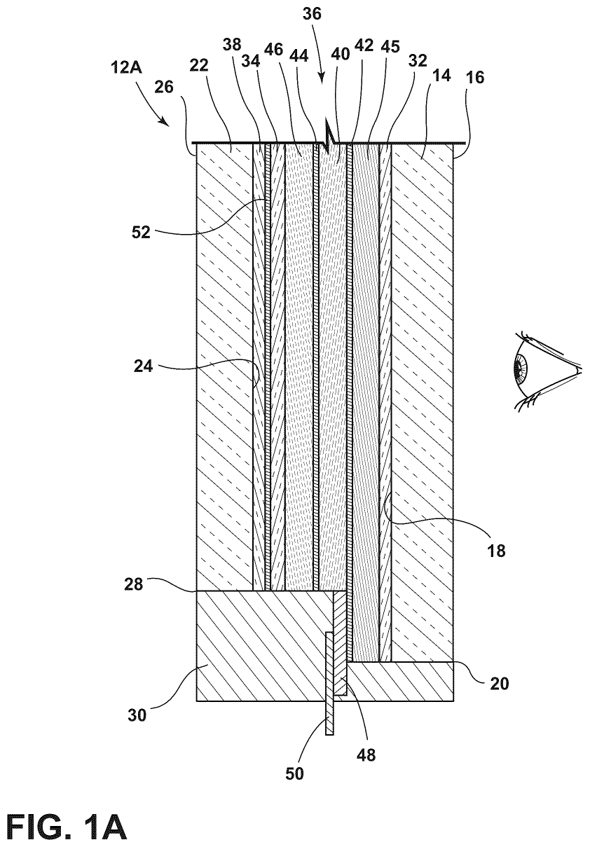

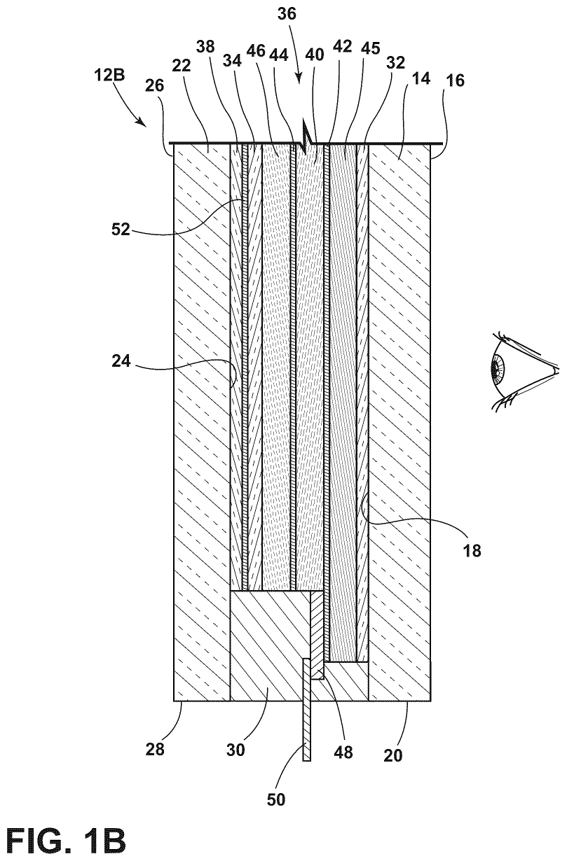

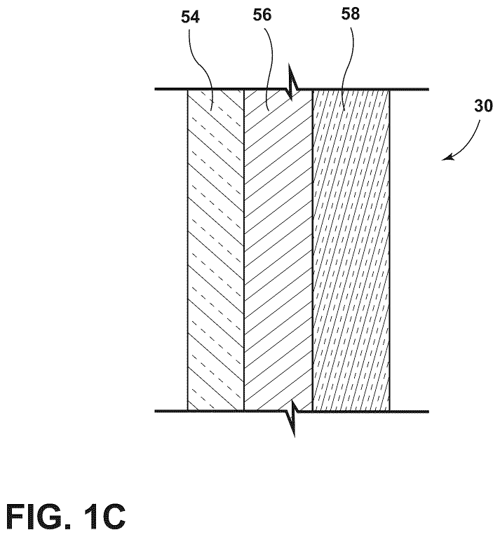

For purposes of description herein, the terms “upper,” “lower,” “right,” “left,” “rear,” “front,” “vertical,” “horizontal,” and derivatives thereof, shall relate to the disclosure as oriented in FIGS. 1A and 1B. Unless stated otherwise, the term “front” shall refer to a surface of the device closest to an intended viewer, and the term “rear” shall refer to a surface of the device furthest from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

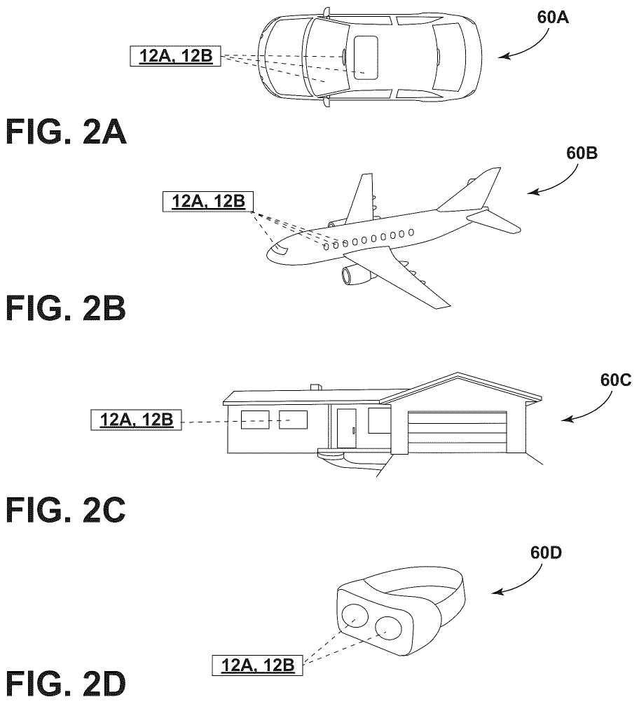

Referring to FIGS. 1A and 2A-2D, reference numeral 12A generally designates a variable transmission element of a first construction. The variable transmission element 12A includes a first substrate 14 defining a first surface 16 that is oriented towards the front of the variable transmission element 12A, a second surface 18 opposite from the first surface 16, and a first perimeter 20 defining an outer boundary of the first surface 16 and the second surface 18. The first substrate 14 may be substantially transparent. The variable transmission element 12A also includes a second substrate 22 defining a third surface 24 that is oriented towards the front of the variable transmission element 12A, a fourth surface 26 opposite from the third surface 24, and a second perimeter 28 defining an outer boundary of the third surface 24 and the fourth surface 26. The second substrate 22 may be substantially transparent. The first and second substrates 14, 22 are disposed in a spaced apart relationship to define a space therebetween. A seal 30 is formed of a sealing material and extends along the perimeters 20, 28 of the first and second substrates 14, 22. A first lamination layer 32 comprises a first lamination material that is different from the sealing material and the first lamination layer 32 is coupled to the first substrate 14. A second lamination layer 34 comprises a second lamination material that is different from the sealing material and the second lamination layer 34 is coupled to the second substrate 22. An electro-optic device 36 (e.g., an electro-optic medium 40) is disposed between the first lamination layer 32 and the second lamination layer 34 and may be and generally coextensive with the first lamination layer 32 and the second lamination layer 34.

With specific reference to FIG. 1A, the variable transmission element 12A may include a third lamination layer 38 comprising a third lamination material that may be different from at least one of the first lamination material and the second lamination material and is disposed between the second substrate 22 and the electro-optic device 36. The first lamination layer 32 may be coupled to (e.g., directly connected to and/or applied to) the second surface 18 and may extend to the first perimeter 20. The second lamination layer 34 may be located between the second substrate 22 and the electro-optic device 36. In some embodiments, the third lamination layer 38 may be coupled to (e.g., directly connected to and/or applied to) the third surface 24 and may extend to the second perimeter 28. Therefore, in some embodiments, the second lamination layer 34 may be located between the third lamination layer 38 and the electro-optic device 36.

In some embodiments, the first lamination material may be different than the second lamination material. For example, in some embodiments, the third lamination material may be the same as the first lamination material and different than the second lamination material. In other embodiments, the third lamination material may be different from the first lamination material and the same as the second lamination material. In still other embodiments, the third lamination material may be different from the first lamination material and different than the second lamination material. In further embodiments, the first lamination material and the second lamination material may be the same and different than the third lamination material. In any arrangement of the above-described compositions of the lamination materials, the third lamination material may also be different than the sealing material.

With continued reference to FIG. 1A, the sealing material may include an adhesive, a thermoplastic material, a thermosetting or vulcanized material, epoxy (e.g., a two-part epoxy), a liquid form, and/or at least two distinct materials. However, it should be appreciated that the sealing material could include other compositions, for example, compositions that do not include thermoplastic polyurethane (“TPU”), polyvinyl butyral (“PVB”), ethylene vinyl acetate (“EVA”), and/or other thermoplastics. The first through third lamination materials, on the other hand, may include one, two, or more of TPU, PVB, and EVA. In some embodiments, the EVA material includes a peroxide. For example, the peroxide may have a content that is a low percentage of the total composition such that only a portion of the EVA is cured. In some embodiments, less than 80% of the EVA is cured by the peroxide content, for example, less than 60%, less than 40%, or less than 20%. In some embodiments, the EVA contains no peroxide (or any other catalyst) and a catalyst, such as peroxide, is applied to discrete regions of the second surface 18, the third surface 24, the perimeters 20, 28 of the substrates 14, 22, outer regions of the laminates 32, 34, 38, the electro-optic device 36, or other components of the variable transmission element 12A such that only select portions of the EVA is cured (i.e., cross-linked).

With still continued reference to FIG. 1A, the electro-optic device 36 includes an electro-optic medium 40. As depicted, the electro-optic device 36 may be configured as a solid-state device such that the electro-optic medium 40 includes an electrolyte film. The electrolyte film may include cathodic materials, anodic materials, and electrolyte materials. However, it should be appreciated that the electro-optic device 36 may be configured as a solution-phase device, such that the electro-optic medium 40 is liquid or gel containing at least one solvent, at least one anodic material, and at least one cathodic material. The electro-optic medium 40 may be switchable between a transmissive state (e.g., greater than 40%, 50%, and 60% transmission in a visible spectrum) and a substantially darkened state. In other embodiments, a reflective or transreflective layer (not shown) is located between the electro-optic medium 40 and the fourth surface 26 such that increasing the transmissive state increases the amount of reflected light.

With continued reference to FIG. 1A, the electro-optic device 36 include a first electrode layer 42 and a second electrode layer 44 and the electro-optic medium 40 may be sandwiched therebetween. The electro-optic device 36 may further include a first charge storage layer 45 (i.e., a first device substrate) and a second charge storage layer 46 (i.e., a second device substrate). The first electrode layer 42 may be disposed on the first charge storage layer 45 and the second electrode layer 44 may be disposed on the second charge storage layer 46. The first charge storage layer 45 and the second charge storage layer 46 may be formed of polyethylene terephthalate (“PET”), one or more plastics, or multi-plastic stacks. The first electrode layer 42 and the second electrode layer 44 may be formed by electrically conductive transparent materials, including, but not limited to, a transparent conducting film (e.g., indium tin oxide (ITO), F:SnO2, ZnO, IZO), insulator-metal-insulator (“IMI”) structures, carbon (graphene and/or graphite) and/or a conductive metal mesh (e.g., nanowires). An electric bus 48 may at least partially travel along a peripheral edge of the electro-optic medium 40. For example, the electric bus 48 may include one or more of a conductive adhesive, a metallic strip, tape, and/or the like, that may include a higher electric conductivity than one of or both of the first electrode layer 42 and the second electrode layer 44. In some embodiments, the electric bus 48 may include the metallic strip or tape with the conductive adhesive in electrical communication between the electric bus 48 and the first and second electrode layers 42, 44. The electric bus 48 may be placed on an internal surface (e.g., a surface that faces towards the electro-optic medium 40) of the first electrode layer 42 and/or the second electrode layer 44 or the electric bus 48 may be placed on an outer surface (e.g., a surface that faces away from the electro-optic medium 40) of the first electrode layer 42 and/or the second electrode layer 44. In some instances, the electric bus 48 may transverse an entire perimeter of the electro-optic medium 40 or may be localized to one or more discrete locations.

With continued reference to FIG. 1A, the seal 30 may substantially cover the electric bus 48. In some embodiments, one or more conductive intermediaries 50 are connected to the electric bus 48 and extend through the seal 30 for connecting a power source and control system (not shown). The conductive intermediary 50 may include a clip, conductive paste, conductive adhesive, conductive ink, wire, and/or the like. In some embodiments, the seal 30 may extend around and contact the perimeters 20, 28 of the first and second substrates 14, 22 and an outer perimeter of the intermediary components (e.g., the electro-optic device 36 and lamination layers 32, 34, and 38). In such embodiments, the seal 30 may not be in direct contact with second or third surfaces 18, 24. In some embodiments, a solar control layer 52 is located between the second substrate 22 and the electro-optic device 36, for example, between the second and third lamination layers 34, 38. The solar control layer 52 may be configured to reflect light within a visible or non-visible spectrum. For example, the solar control layer 52 may be configured to reflect light in the infrared spectrum while transmitting light in the visible spectrum.

With reference now to FIG. 1B, a variable transmission element 12B of a second construction is illustrated. Unless otherwise explicitly stated, the variable transmission element 12B of the second construction may share all of the same components, functionalities, materials, and configurations as the variable transmission element 12A of the first construction. However, the seal 30 in the variable transmission element 12B of the second construction is located between the first and second substrates 14, 22 such that it directly contacts and is sandwiched between the second and third surfaces 18, 24.

With reference now to FIG. 1C, the seal 30 included in the first and second constructions of the variable transmission element 12A, 12B may include layers of the sealing material. The layers of sealing material may include two or more layers of different types of sealing material. Each layer may extend between the second and third surfaces 18, 24 (i.e., in the variable transmission element 12A) or at least partially across and in contact with the perimeters 20, 28 of the first and second substrates 14, 22 (e.g., the variable transmission element 12B). The layers may include a first layer 54, a second layer 56, and a third layer 58. The second layer 56 may be disposed between the first and third layers 54, 58. In some embodiments, each of the layers 54, 56, and 58 are formed of a different sealing material. In other embodiments, two of the layers 54, 56, and 58 are formed of a different sealing material and two of the layers 54, 56, and 58 are formed of the same sealing material. For example, the second layer 56 may be formed of a different material than the first and third layers 54, 58 and the first and third layers 54, 58 may be formed of the same sealing material. The sealing materials may be selected from a group that includes an adhesive, a thermoplastic material, a thermosetting or vulcanized material, epoxy (e.g., a two-part epoxy), a liquid form, or at least two distinct materials, a catalyst (e.g., a thermosetting catalyst). In some embodiments, the third layer 58 is inboard from the first and second layers 54, 56 and includes the catalyst. As such, it is contemplated that less than 80% of the second layer 56 is cured by the catalyst, for example, less than 60%, less than 40%, or less than 20%. In this manner, in some embodiments, the third layer 58 may be a cured sealing material and an outer layer (e.g., the second layer 56) may be the same sealing material that is uncured. In other embodiments, an outer layer (e.g., the first or second layer 54, 56) may be a cured sealing material and an inner layer (e.g., the second or third layer 56, 58) may be the same sealing material that is cured. In some embodiments, the seal 30 (e.g., one or more layers 54, 56, 58) can be cured with an Ebeam to selectively cross-link the sealing material. The sealing material in the one or more layers 54, 56, 58 may be selected for liquid barrier and/or gas barrier properties.

With reference now to FIGS. 1A-1C, to reduce optical distortions that may develop during assembly, one or more of the lamination layers 32, 34, and 38 may be 15 mm or less, 3 mm or less, 1.5 mm or less, or 15 μm or less. One or more of the lamination materials may be TPU, EVA, or PVB with a high molecular weight, for example, such that the lamination materials exhibit less than 3,000,000 Centipoise at 200° C. In some embodiments, at least one of the lamination materials is PVB and exhibits less than 2,500,000 Centipoise at 200° C., or around 2,123,000 Centipoise at 200° C. and produces high levels of optical uniformity. The lamination materials may include different combinations of TPU, PVB, and/or EVA. Each lamination material may be homogeneous. In some embodiments, at least one lamination material comprises EVA with the peroxide content.

As it relates to both the first and second constructions, in some embodiments, the first lamination material is formed of TPU, the second lamination material is formed as one of PVB or EVA, and the third lamination material is formed as one of PVB or EVA (e.g., different than the second lamination material). In some embodiments, the first lamination material is formed of PVB, the second lamination material is formed as one of TPU or EVA, and the third lamination material is formed as one of TPU or EVA (e.g., different than the second lamination material). In further embodiments, the first lamination material is formed of EVA, the second lamination material is formed as one of PVB or TPU, and the third lamination material is formed as one of PVB or TPU (e.g., different than the second lamination material). In some embodiments, the second lamination material is formed of PVB, the first lamination material is formed as one of TPU or EVA, and the third lamination material is formed as one of TPU or EVA (e.g., different than the first lamination material). In further embodiments, the second lamination material is formed of EVA, the first lamination material is formed as one of PVB or TPU, and the third lamination material is formed as one of PVB or TPU (e.g., different than the first lamination material). In some embodiments, the third lamination material is formed of PVB, the first lamination material is formed as one of TPU or EVA, and the second lamination material is formed as one of TPU or EVA (e.g., different than the first lamination material). In further embodiments, the third lamination material is formed of EVA, the first lamination material is formed as one of PVB or TPU, and the second lamination material is formed as one of PVB or TPU (e.g., different than the first lamination material).

With reference now to FIGS. 2A-2D, the variable transmission element 12A, 12B may be incorporated with one or more structures 60A-60C. For example, FIG. 2A illustrates an automobile 60A employing the variable transmission element 12A, 12B, for example, with an interior rearview mirror, a sunroof, a windshield, a side window, a heads-up display, and/or other interior vehicle locations that display one or more aspects of the variable transmission element 12A, 12B. The automobile 60A may include a commercial vehicle, an emergency vehicle, a residential vehicle, or the like. FIG. 2B illustrates an aircraft 60B employing the variable transmission element 12A, 12B (e.g., a front window, side window, and/or a heads-up display). FIG. 2C illustrates a building 60C employing variable transmission element 12A, 12B (e.g., a window). The building 60C may be a residential building, a commercial building, and/or the like. Generally speaking, the variable transmission element 12A, 12B may be incorporated into any environment where it is beneficial to change the state of a window, mirror, and/or display. FIG. 2D illustrates eyewear 60D employing variable transmission element 12A, 12B. For example, the eyewear 60D may include glasses with dimming functionality, augmented reality, or semi-augmented reality. Other structures may incorporate the variable transmission element 12A, 12B where switching between transmission and/or reflective states (e.g., an electro-optic configuration in structures 60A-60D) may be beneficial.

The disclosure herein is further summarized in the following paragraphs and is further characterized by combinations of any and all of the various aspects described therein.

According to one aspect of the present disclosure, a variable transmission element includes a first substrate that has a first surface and a second surface opposite the first surface. A second substrate includes a third surface and a fourth surface opposite the third surface. The first and second substrates are disposed in a spaced apart relationship so as to define a space therebetween with the second and third surfaces facing each other. A seal is formed of a sealing material and extends along a perimeter of the first and second substrates. A first lamination layer comprises a first lamination material that is different from the sealing material and the first lamination layer is coupled to the second surface. A second lamination layer comprises a second lamination material that is different from the sealing material and the second lamination layer is coupled to the second substrate. An electro-optic device is disposed between the first lamination layer and the second lamination layer.

According to another aspect, the first lamination material is different than the second lamination material.

According to yet another aspect, a third lamination layer comprises a third lamination material different from at least one of the first lamination material and the second lamination material, and disposed between the second substrate and the electro-optic device.

According to still yet another aspect, the third lamination material is different than the first lamination material.

According to another aspect, the sealing material includes an adhesive.

According to yet another aspect, the sealing material comprises one of a thermoplastic material, a thermosetting or vulcanized material, epoxy, a liquid form, or at least two distinct materials.

According to still yet another aspect, the sealing material extends between the second and third surfaces, substantially within the perimeter of the first and second substrates.

According to another aspect, the sealing material extends substantially outside of the perimeter of the first and second substrates.

According to another aspect of the present disclosure, a variable transmission element includes a first substrate that has a first surface and a second surface opposite the first surface. A second substrate includes a third surface and a fourth surface opposite the third surface. The first and second substrates are disposed in a spaced apart relationship so as to define a space therebetween with the second and third surfaces facing each other. A first lamination layer comprises a first lamination material and the first lamination layer is coupled to the second surface. A second lamination layer comprises a second lamination material that is different from the first lamination material and the second lamination layer is coupled to the second substrate. An electro-optic device is disposed between the first lamination layer and the second lamination layer.

According to another aspect, a seal comprises a sealing material extending between the second and third surfaces along a perimeter of the first and second substrates.

According to yet another aspect, a third lamination layer comprises a third lamination material different from at least one of the first lamination material and the second lamination material, and disposed between the second substrate and the electro-optic device.

According to still yet another aspect, the third lamination material is different than the first lamination material.

According to another aspect, the third lamination material is different than the second lamination material.

According to yet another aspect, at least one of the lamination materials comprises Ethylene Vinyl Acetate with a peroxide.

According to still yet another aspect, the sealing material is different than the first and second lamination materials.

According to yet another aspect of the present disclosure, a variable transmission element includes a first substrate that has a first surface and a second surface opposite the first surface. A second substrate includes a third surface and a fourth surface opposite the third surface. The first and second substrates are disposed in a spaced apart relationship so as to define a space therebetween with the second and third surfaces facing each other. An electro-optic is device disposed between the first and second substrates. A seal formed of a sealing material that does not include thermoplastic polyurethane (“TPU”), polyvinyl butyral (“PVB”), ethylene vinyl acetate (“EVA”) extends along a perimeter of the first and second substrates. A first lamination layer comprises a first lamination material selected from a group comprising TPU, PVB, and EVA that is located between the second surface and the electro-optic device. A second lamination layer comprises a second lamination material selected from a group comprising TPU, PVB, and EVA that is located between the third surface and the electro-optic device.

According to another aspect, a variable transmission element includes a third lamination layer comprising a third lamination material selected from a group comprising TPU, PVB, and EVA that is located between a third surface and a second lamination material.

According to yet another aspect, third lamination material is different than at least one of a first lamination material and a second lamination material.

According to still another aspect, a solar control layer is located between a second lamination layer and a third lamination layer.

According to another aspect, an electro-optic device includes an electro-optic medium located between a first storage layer and a second storage layer, the first storage layer located between a first lamination layer and the electro-optic medium and the second storage layer located between a second lamination material and the electro-optic medium.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A variable transmission element comprising:
a first substrate having a first surface and a second surface opposite the first surface;
a second substrate having a third surface and a fourth surface opposite the third surface, the first and second substrates disposed in a spaced apart relationship so as to define a space therebetween, the second and third surfaces facing each other;
a seal formed of a sealing material extending along a perimeter of the first and second substrates;
a first lamination layer comprising a first lamination material different from the sealing material, and coupled to the second surface;
a second lamination layer comprising a second lamination material different from the sealing material, and coupled to the second substrate; and
an electro-optic device disposed between the first lamination layer and the second lamination layer.

2. The variable transmission element of claim 1, wherein the first lamination material is different than the second lamination material.

3. The variable transmission element of claim 1, further including a third lamination layer comprising a third lamination material different from at least one of the first lamination material and the second lamination material, and disposed between the second substrate and the electro-optic device.

4. The variable transmission element of claim 3, wherein the third lamination material is different than the first lamination material.

5. The variable transmission element of claim 1, wherein the sealing material includes an adhesive.

6. The variable transmission element of claim 1, wherein the sealing material comprises one of a thermoplastic material, a thermosetting or vulcanized material, epoxy, a liquid form, or at least two distinct materials.

7. The variable transmission element of claim 1, wherein the sealing material extends between the second and third surfaces, substantially within the perimeter of the first and second substrates.

8. The variable transmission element of claim 1, wherein the sealing material extends substantially outside of the perimeter of the first and second substrates.

9. A variable transmission element comprising:
a first substrate having a first surface and a second surface opposite the first surface;
a second substrate having a third surface and a fourth surface opposite the third surface, the first and second substrates disposed in a spaced apart relationship so as to define a space therebetween, the second and third surfaces facing each other;
a first lamination layer comprising a first lamination material coupled to the second surface;
a second lamination layer comprising a second lamination material different from the first lamination material, and coupled to the second substrate; and
an electro-optic device disposed between the first lamination layer and the second lamination layer.

10. The variable transmission element of claim 9, further including a seal comprising a sealing material extending between the second and third surfaces along a perimeter of the first and second substrates.

11. The variable transmission element of claim 9, further including a third lamination layer comprising a third lamination material different from at least one of the first lamination material and the second lamination material, and disposed between the second substrate and the electro-optic device.

12. The variable transmission element of claim 11, wherein the third lamination material is different than the first lamination material.

13. The variable transmission element of claim 11, wherein the third lamination material is different than the second lamination material.

14. The variable transmission element of claim 13, wherein at least one of the lamination materials comprises ethylene vinyl acetate with a peroxide.

15. The variable transmission element of claim 10, wherein the sealing material is different than the first and second lamination materials.

16. A variable transmission element comprising:
a first substrate having a first surface and a second surface opposite the first surface;
a second substrate having a third surface and a fourth surface opposite the third surface, the first and second substrates disposed in a spaced apart relationship so as to define a space therebetween, the second and third surfaces facing each other;
an electro-optic device disposed between the first and second substrates;
a seal formed of a sealing material that does not include thermoplastic polyurethane (“TPU”), polyvinyl butyral (“PVB”), ethylene vinyl acetate (“EVA”) and that extends along a perimeter of the first and second substrates;
a first lamination layer comprising a first lamination material selected from a group comprising TPU, PVB, and EVA that is located between the second surface and the electro-optic device; and
a second lamination layer comprising a second lamination material different selected from a group comprising TPU, PVB, and EVA that is located between the third surface and the electro-optic device.

17. The variable transmission element of claim 16, further including a third lamination layer comprising a third lamination material selected from a group comprising TPU, PVB, and EVA that is located between the third surface and the second lamination material.

18. The variable transmission element of claim 17, wherein the third lamination material is different than at least one of the first lamination material and the second lamination material.

19. The variable transmission element of claim 17, wherein a solar control layer is located between the second lamination layer and the third lamination layer.

20. The variable transmission element of claim 19, wherein the electro-optic device includes an electro-optic medium located between a first storage layer and a second storage layer, the first storage layer located between the first lamination layer and the electro-optic medium and the second storage layer located between the second lamination material and the electro-optic medium.
